(19) United States
(12) Patent Application Publication
(10) Pub. No.: US 2007/0242213 A1
(43) Pub. Date: Oct. 18, 2007

(54) Book light with housing for reading glasses

(75) Inventor: Sean Grillo, San Antonio, TX (US)

Correspondence Address: JAMES RAY & ASSOCIATES, 2640 PITCAIRN ROAD, MONROEVILLE, PA, 15146, US

(73) Assignee: ROCCO ORIGINALS, LTD.

(21) Appl. No.: 11/602,858

(22) Filed: Nov. 21, 2006

Related U.S. Application Data
(60) Provisional application No. 60/792,157, filed on Apr. 13, 2006.

(51) Int. Cl. G02C 5/00

(52) U.S. Cl. 351/141

(57) ABSTRACT

A combination eye glass case and reading light. Such eye glass case includes an elongated generally hollow glass housing member for receiving a pair of glasses therein. The housing member is open at a first end thereof and is generally rectangular both in plan view and in a cross sectional view in each of a longitudinal direction and a direction transverse to such longitudinal direction. A cap member engages the housing member and closing such open first end thereof. A light fixture is hingedly attached to a second end of such housing member for providing a light at least sufficient to read by. A power source is disposed within the housing member and connected to such light fixture for providing power thereto. A switch means is disposed on such housing member and electrically connected between the power source and the light fixture to turn on and off such light fixture.

### CROSS REFERENCE TO RELATED APPLICATION

This patent application is related to and claims priority benefit from U.S. Provisional Patent Application Ser. No. 60/792,157 filed Apr. 13, 2006.

### FIELD OF THE INVENTION

The present invention relates, in general, to glass cases used to protect glasses from getting scratched when such glasses are not being worn and, more particularly, this invention relates to a glass case for holding one of prescription eye glasses and reading glasses which is equipped with a light to provide sufficient illumination to read by.

### BACKGROUND OF THE INVENTION

Prior to the conception and development of the present invention, glass cases have been used for many years to protect eye glasses from getting scratched when such glasses are not being worn.

Additionally, applicant is aware of a number of portable book lights for providing sufficient illumination while reading in bed, for example, but none of these prior art type reading lights teach or suggest such light could be provided in combination with a glass case.

U.S. Pat. No. 4,432,042, for example, teaches a portable book light which is relatively small and light weight. This light is formed from a plastic material and includes a base which supports a vertical lamp bearing arm mounted at one end in a transverse slot in such base. The other end of the vertical arm supports the lamp proper in a manner to allow both a circular and a vertical motion. This book light also includes a clamp means attached to the base so that the entire book light can be attached to a book.

Applicant is also aware of U.S. Pat. No. 4,598,340 which teaches a portable book light that can be easily attached to the object to be illuminated. This particular book light includes a self contained energy source and provides a shield to prevent the light bulb from coming into contact with and possibly burning other objects.

Finally, applicant is aware of U.S. Pat. No. 6,361,184 which provides a lighting device that is convertible between a reading light and a flashlight.

As discussed supra none of these prior art reading lights provide a storage space for eye glasses when they are not being used.

### SUMMARY OF THE INVENTION

The present invention provides an eye glass case equipped with a reading light. Such eye glass case includes an elongated generally hollow glass housing member for receiving a pair of glasses therein. Such glass housing member is open at a predetermined first end thereof. Additionally, such glass housing member is formed from a predetermined material and has a predetermined size. The glass housing member is generally rectangular both in plan view and in a cross sectional view in each of a longitudinal direction and a direction transverse to the longitudinal direction. A cap member is engageable with such glass housing member for closing the open first end thereof. This cap member is also formed from a predetermined material. There is a light fixture hingedly attached to a second end of such glass housing member for providing a light at least sufficient to read by. A power source is disposed within such glass housing member and is connected to such light fixture for providing power thereto and a switch means is disposed on such glass housing member and electrically connected between such power source and the light fixture to turn on and off such light fixture.

### OBJECTS OF THE INVENTION

It is, therefore, one of the primary objects of the present invention to provide an eye glass case which can further serve as a reading light.

Another object of the present invention is to provide an eye glass case which can further serve as a reading light that is relatively lightweight.

Still another object of the present invention is to provide an eye glass case which can further serve as a reading light that is relatively inexpensive to manufacture.

Yet another object of the present invention is to provide an eye glass case which can further serve as a reading light that is easy to use.

An additional object of the present invention is to provide an eye glass case which can further serve as a reading light that can be manufactured in a number of shapes, sizes and colors.

An additional object of the present invention is to provide an eye glass case which can be manufactured using a variety of materials including a combination of different materials such as metals and plastics.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of a presently preferred embodiment of the combination eye glass case and reading light constructed according to the invention;

FIG. 2 is a top view of the combination eye glass case and reading light illustrated in FIG. 1;

FIG. 3 is a side elevation view of the combination eye glass case and reading light illustrated in FIGS. 1 and 2; and

FIG. 4 is a view of the combination eye glass case and reading light illustrated in FIGS. 1-3 with the top portion removed to show the eye glasses contained therein.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

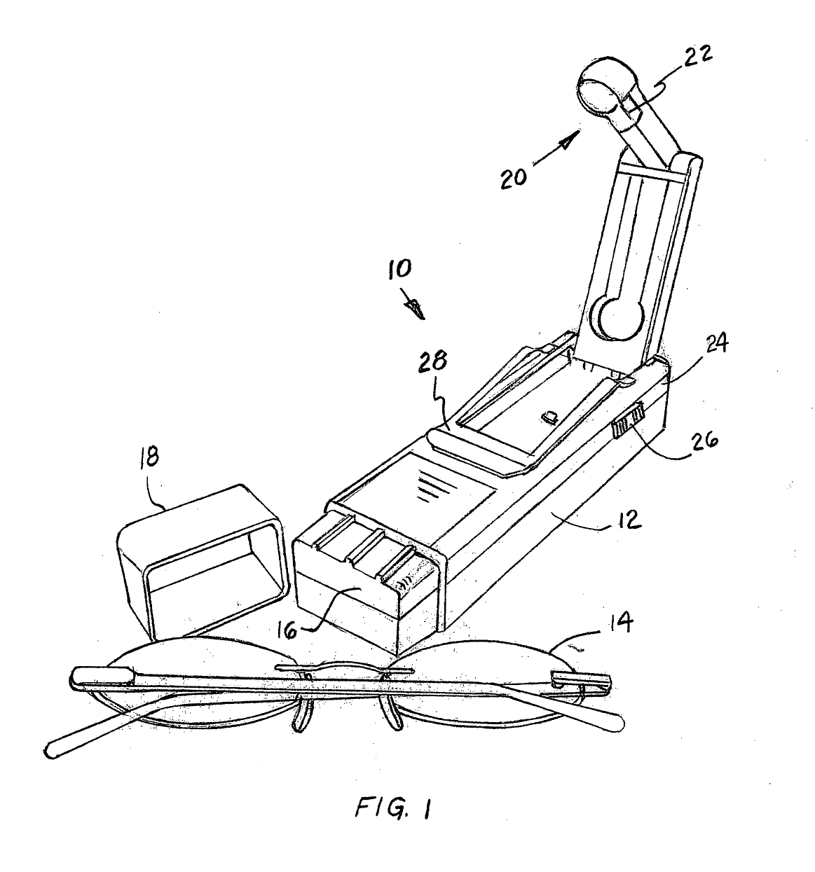

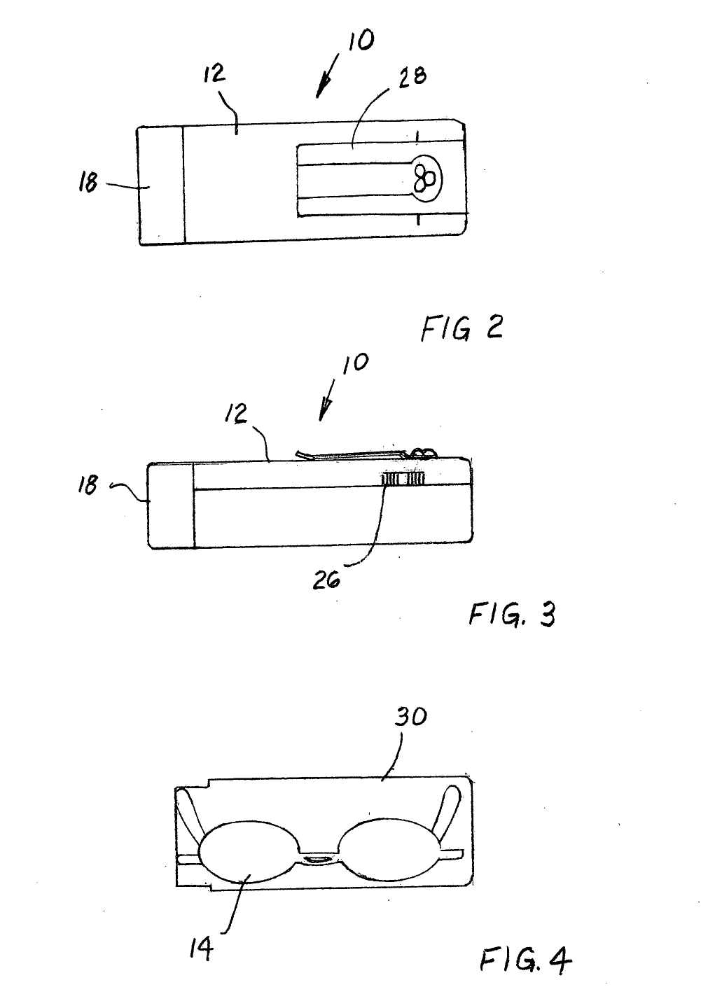

Now reference is made, more particularly, to FIGS. 1-4 of the drawings. Illustrated therein is an eye glass case, generally designated 10, which is equipped with a reading light, generally designated 20. Such eye glass case 10 includes an elongated generally hollow glass housing member 12 for receiving a pair of glasses 14 therein. The glass housing member 12 being open at least at a first end 16 thereof. The glass housing member 12 is formed from a predetermined material and has a predetermined size. Such glass housing member 12 being generally rectangular both in plan view and in a cross sectional view in each of a longitudinal direction and a direction transverse to such longitudinal direction. Such generally hollow glass housing member 12 preferably includes a lining member 30 to protect such eye glasses 14 against scratching.

A cap member 18 is engageable with such glass housing member 12 for closing the open first end 16 thereof. Such cap member 18 is formed from a predetermined material.

In the presently preferred embodiment of the invention such predetermined material the glass housing member 12 and such cap member 18 is formed from will be substantially identical. Normally, such predetermined material that the glass housing member 12 and the cap member 18 is formed from will be selected from the group consisting of plastic and metal. Such metal being one of steel and aluminum. Preferably, such metal is aluminum. The predetermined material that the glass housing member 12 and the cap member 18 is formed from in some instances may preferably be multi colored plastic due to cost considerations.

In the presently preferred embodiment of the invention it should be noted that the cap member 18 engages such glass housing member 12 by way of one of an interlocking fit and a friction fit. The most preferred fit is an interlocking type fit.

There is a light fixture 22 hingedly attached to a second end 24 of such glass housing member 12 for providing at least a sufficient light to read by. Further, it is presently preferred that such light fixture 22 has an LED type light. Additionally, the light fixture 22 should be extendable as well as swivel.

A power source (not shown) preferably a rechargeable battery is disposed within such glass housing member 12 and connected to the light fixture 22 for providing power thereto.

Finally, switch means 26 is disposed on such glass housing member 12 and is electrically connected between such power source and such light fixture 22 to turn on and off the light fixture 22.

Eye glass case 10 further includes, in the presently preferred embodiment, a clip means 28 mounted on a same side as such light fixture 22 for clipping to one of a book (not shown) while in use and a pocket (not shown) when not in use.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An eye glass case equipped with a reading light, said eye glass case comprising:
(a) an elongated generally hollow glass housing member for receiving a pair of glasses therein, said glass housing member being open at least at a first end thereof and formed from a predetermined material and having a predetermined size, said glass housing member being generally rectangular both in plan view and in a cross sectional view in each of a longitudinal direction and a direction transverse to said longitudinal direction;
(b) a cap member engageable with said glass housing member for closing said open first end thereof, said cap member being formed from a predetermined material;
(c) a light fixture hingedly attached to a second end of said glass housing member for providing at least a sufficient light to read by;
(d) a power source disposed within said glass housing member and connected to said light fixture for providing power thereto; and
(e) a switch means disposed on said glass housing member and electrically connected between said power source and said light fixture to turn on and off said light fixture.

2. An eye glass case, according to claim 1, wherein said predetermined material said glass housing member and said cap member is formed from is substantially identical.

3. An eye glass case, according to claim 2, wherein said predetermined material said glass housing member and said cap member is formed from is selected from the group consisting of plastic and metal.

4. An eye glass case, according to claim 3, wherein said metal is one of steel and aluminum.

5. An eye glass case, according to claim 3, wherein said predetermined material said glass housing member and said cap member is formed from is plastic.

6. An eye glass case, according to claim 1, wherein said cap member engages said glass housing member by way of one of an interlock and a friction fit.

7. An eye glass case, according to claim 6, wherein said cap member engages said glass housing member by way of one of an interlocking fit.

8. An eye glass case, according to claim 1, wherein said light fixture is an LED type light.

9. An eye glass case, according to claim 8, wherein said light fixture is extendable.

10. An eye glass case, according to claim 1, wherein said light fixture swivels.

11. An eye glass case, according to claim 1, wherein said power source is a battery.

12. An eye glass case, according to claim 11, wherein said battery is rechargeable.

13. An eye glass case, according to claim 1, wherein said eye glass case further includes a clip means mounted on a same side as said light fixture for clipping to one of a book while in use and a pocket when not in use.

14. An eye glass case, according to claim 1, wherein said eye glass case is multi colored.

15. An eye glass case, according to claim 1, wherein said generally hollow glass housing member includes a lining to protect such eye glasses against scratching.
